(19) United States
(12) Patent Application Publication
(10) Pub. No.: US 2014/0128018 A1
(43) Pub. Date: May 8, 2014

(54) TIME OBTAINING METHOD AND APPARATUS, AND MOBILE TERMINAL

(71) Applicant: Huawei Device Co., Ltd., Shenzhen (CN)

(72) Inventor: Yanzhao HE, Beijing (CN)

(73) Assignee: Huawei Device Co., Ltd., Shenzhen (CN)

(21) Appl. No.: 14/140,995

(22) Filed: Dec. 26, 2013

Related U.S. Application Data
(63) Continuation of application No. PCT/CN2011/085004, filed on Dec. 30, 2011.

(51) Int. Cl. H04W 56/00; H04W 4/22

(52) U.S. Cl. CPC H04W 56/001; H04W 4/22
USPC 455/404.1; 455/566

(57) ABSTRACT

A time obtaining method includes: receiving, by a mobile terminal, a time obtaining request, and determining whether the mobile terminal has access to a network service; initiating, by the mobile terminal, an emergency call when the mobile terminal has no access to a network service; receiving a sync channel message which is obtained through searching during the emergency call process and terminating the emergency call, where the sync channel message carries time information; and obtaining time according to the time information. In the present invention, in a situation where time synchronization needs to be implemented and a mobile terminal has no access to a network service, time is obtained from a network side without affecting other services.

### CROSS-REFERENCE TO RELATED APPLICATIONS

This application is a continuation of International Patent Application No. PCT/CN2011/085004, filed on Dec. 30, 2011, which is hereby incorporated by reference in its entirety.

### TECHNICAL FIELD

The present invention relates to the field of mobile terminals, and in particular, to a time obtaining method and apparatus, and a mobile terminal.

### BACKGROUND

With the development of mobile phone technologies and users' increasing dependence on mobile phones, performance requirements of mobile phones are increasingly high. As a main function of a mobile phone, a clock is used frequently, and requirements on the clock are high. Existing CDMA mobile phones universally support the function of obtaining network time. When an existing CDMA (Code Division Multiple Access) mobile phone is registered on a network, the CDMA mobile phone obtains current network time through computing according to parameters in a sync channel message, thereby achieving time synchronization to ensure accuracy of the clock of the mobile phone.

In a process of implementing the present invention, it is found that the prior art has at least the following problems.

In the prior art, only when a mobile phone is registered on a network can the mobile phone obtain current network time. If a current mobile phone (phone-card separated version) does not have a UIM (User Identity Model, user identity model) card, or a PIN (Personal Identification Number, personal identification number) code thereof is locked, or the phone-card integrated version mobile phone cannot be registered on a network due to some reason like roaming setting, the mobile phone cannot obtain network time, so that when having no access to a network service, the mobile phone cannot implement real-time updating of time.

### SUMMARY

In order to solve a problem that a mobile phone cannot implement real-time updating of time when having no access to a network service, embodiments of the present invention provide a time obtaining method and apparatus, and a mobile terminal. The technical solutions are described as follows:

An embodiment of the present invention provides a time obtaining method, including:

receiving, by a mobile terminal, a time obtaining request, and determining whether the mobile terminal has access to a network service;

initiating, by the mobile terminal, an emergency call when the mobile terminal has no access to a network service;

receiving a sync channel message which is obtained through searching during the emergency call process and terminating the emergency call, where the sync channel message carries time information; and

obtaining time according to the time information.

An embodiment of the present invention provides a time obtaining apparatus, including:

a judging module, configured to receive a time obtaining request and determine whether a mobile terminal has access to a network service;

an emergency call module, configured to initiate an emergency call by the mobile terminal when the mobile terminal has no access to a network service;

a receiving module, configured to receive a sync channel message which is obtained through searching during the emergency call process, where

the emergency call module is also configured to terminate the emergency call when the receiving module receives the sync channel message which is obtained through searching during the emergency call process, and the sync channel message carries time information; and

an obtaining module, configured to obtain time according to the time information.

An embodiment of the present invention provides a mobile terminal, where the mobile terminal includes the foregoing time obtaining apparatus.

Beneficial effects of the technical solutions provided by the embodiments of the present invention are as follows: in a situation where time synchronization needs to be implemented and a mobile terminal has no access to a network service, the terminal initiates an emergency call and acquires a sync channel message during the emergency call process; once obtaining the sync channel message, the terminal immediately terminates the initiated emergency call process and obtains time according to time information carried in the sync channel message, thereby achieving the purpose of obtaining time from a network side without affecting other services when the terminal has no access to a network service.

### BRIEF DESCRIPTION OF DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a flow chart of a time obtaining method according to an embodiment of the present invention;

FIG. 2 is a flow chart of a time obtaining method according to an embodiment of the present invention;

FIG. 3 is a schematic structural diagram of a time obtaining apparatus according to an embodiment of the present invention; and

FIG. 4 is a schematic structural diagram of a time obtaining apparatus according to an embodiment of the present invention.

### DESCRIPTION OF EMBODIMENTS

To make the objectives, technical solutions, and advantages of the present invention more comprehensible, the following further describes the embodiments of the present invention in detail with reference to the accompanying drawings.

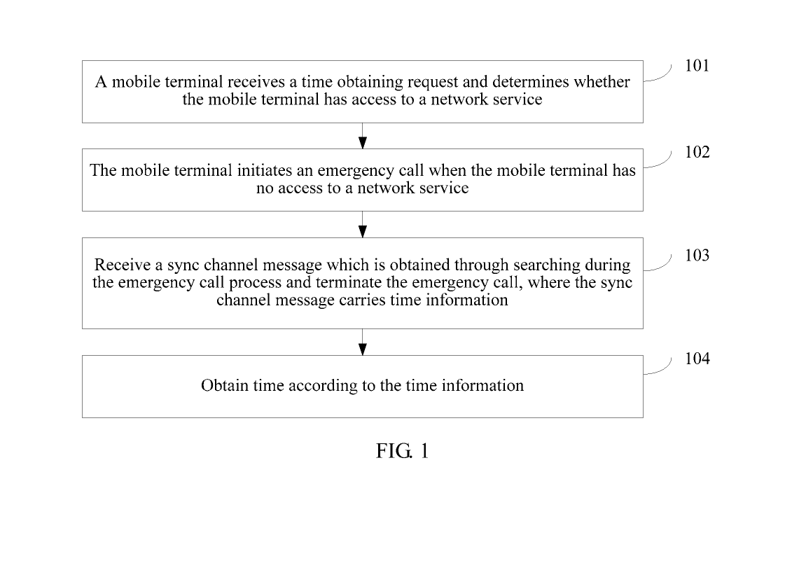

FIG. 1 is a flow chart of a time obtaining method according to an embodiment of the present invention. Referring to FIG. 1, this embodiment includes:

101: A mobile terminal receives a time obtaining request and determines whether the mobile terminal has access to a network service.

102: The mobile terminal initiates an emergency call when the mobile terminal has no access to a network service.

103: Receive a sync channel message which is obtained through searching during the emergency call process and terminate the emergency call, where the sync channel message carries time information.

104: Obtain time according to the time information.

In this method provided by the present invention, in a situation where time synchronization needs to be implemented and a mobile terminal has no access to a network service, the terminal initiates an emergency call and acquires a sync channel message during the emergency call process. Once obtaining the sync channel message, the terminal immediately terminates the initiated emergency call process and obtains time according to time information carried in the sync channel message, thereby achieving the purpose of obtaining time from a network side without affecting other services when the terminal has no access to a network service.

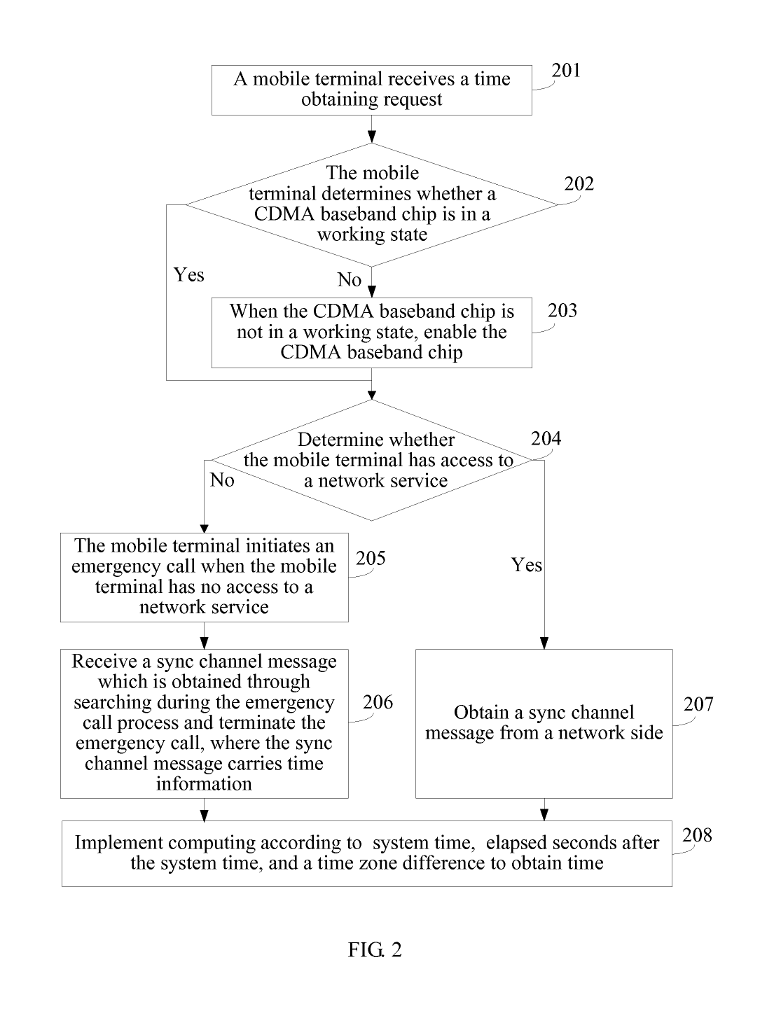

FIG. 2 is a flow chart of a time obtaining method according to an embodiment of the present invention. An executor in this embodiment is a mobile terminal, and the mobile terminal is a mobile terminal including a CDMA baseband chip. Referring to FIG. 2, this embodiment specifically includes:

201: The mobile terminal receives a time obtaining request.

In this embodiment, the time obtaining request may be triggered in multiple manners, which include but are not limited to the following three manners: (1) The mobile terminal displays an interface for manually updating time, where the interface includes a time obtaining option. When needing to obtain time, a user triggers the time obtaining option on the interface for manually updating time provided by the mobile terminal, so that the mobile terminal receives a time obtaining request. (2) When the mobile terminal is delivered or when a user implements setting of the mobile terminal, the mobile terminal is already set to obtain time at a preset interval. Therefore, the mobile terminal periodically triggers a time obtaining request according to the preset interval, so that the mobile terminal receives the time obtaining request. (3) The mobile terminal triggers a time obtaining request when starting up, so that the mobile terminal receives the time obtaining request.

202: The mobile terminal determines whether a CDMA baseband chip is in a working state. If the CDMA baseband chip is in a working state, execute step 204; and if the CDMA baseband chip is not in a working state, execute step 203.

The mobile terminal is a mobile terminal including a CDMA baseband chip, so when the mobile terminal is a mobile terminal including multiple baseband chips, it is possible that the current working baseband chip is not a CDMA baseband chip. As only CDMA supports a time synchronization technology and can implement network search and synchronization with a network so that the mobile terminal can obtain accurate time, it needs to be determined whether the CDMA baseband chip is in a working state.

203: When the CDMA baseband chip is not in a working state, enable the CDMA baseband chip.

Manners of enabling the CDMA baseband chip include but are not limited to the following:

(1) If the mobile terminal includes at least one CDMA baseband chip and the CDMA baseband chip can be completely powered off, when the CDMA baseband chip is not in a working state, power on the CDMA baseband chip through using a main application processor to enable the CDMA baseband chip.

(2) If the mobile terminal includes at least one CDMA baseband chip and the CDMA baseband chip is only in an offline mode, when the CDMA baseband chip is not in a working state, forcibly switch the working mode of the CDMA baseband chip from offline to online to enable the CDMA baseband chip.

204: Use the CDMA baseband chip to determine whether the mobile terminal has access to a network service. If the mobile terminal has access to a network service, execute step 207; and if the mobile terminal has no access to a network service, execute step 205.

After the mobile terminal enables the CDMA baseband chip, the mobile terminal uses the enabled CDMA baseband chip to determine whether the mobile terminal has access to a network service, so as to obtain time information according to the network service.

205: The mobile terminal initiates an emergency call when the mobile terminal has no access to a network service.

There may be many possible reasons for why the mobile terminal has no access to a network service, that is, it does not reside on a network, in a network coverage area. For example, a card is not inserted in the mobile terminal; or the current network is a roaming network, but the user information does not include information about subscribing to a roaming protocol, so the mobile terminal cannot reside on the network; or the user chooses to disable the CDMA baseband chip; or the mobile terminal is in an airplane mode.

In this embodiment, when it is determined that the mobile terminal has no access to a network service, the mobile terminal actively initiates an emergency call. The emergency call process of the mobile terminal includes a network search process, which further includes selecting a channel and attempting to capture a pilot. When a pilot is successfully captured, the mobile terminal can receive a sync channel message sent by a base station. The initiating an emergency call by the mobile terminal specifically includes: invoking an interface for initiating a call, for example, a cm_orig_call( )function (which may have other names on different platforms), selecting a number from an emergency call list, and selecting an emergency call as the call type.

206: Receive a sync channel message which is obtained through searching during the emergency call process and terminate the emergency call, where the sync channel message carries time information, and then execute step 208.

In this embodiment, after initiating an emergency call, the mobile terminal can capture pilot information about a neighboring network through the network search process in the emergency call process. After capturing the pilot information, the mobile terminal can receive a sync channel message from the neighboring network, and after receiving the sync channel message, the terminal must terminate the emergency call, so as to prevent a call error such as a false alarm.

In this embodiment, when initiating the emergency call, the mobile terminal listens to received messages, and when receiving the sync channel message, the mobile terminal terminates the emergency call, for example, by invoking a cm_end_call( )function.

Preferably, if the mobile terminal does not receive the sync channel message during a first preset period of time, the mobile terminal may stop the emergency call and initiate another emergency call after a second preset period of time, thereby attempting to capture pilot information. The first preset period of time and the second preset period of time may be set by technicians during the developing process and are not specifically limited herein.

207: Obtain a sync channel message from a network side, and execute step 208.

When it is determined that the mobile terminal has access to a network service, the mobile terminal obtains a sync channel message from a network side. The specific process is the same as that of the prior art and is not repeated herein.

208: Implement computing according to system time, elapsed seconds after the system time, and a time zone difference to obtain time.

In this embodiment, the time information carried in the sync channel message includes: a sys_time parameter which represents the system time, a lp_sec parameter which represents the elapsed seconds after the system time, a ltm_off parameter which represents the time zone difference, and a DayLT (Daylight savings time indicator) which represents a daylight savings time indicator.

Preferably, the implementing computing according to the system time, the elapsed seconds after the system time, and the time zone difference to obtain time includes:

implementing computing according to the system time, the elapsed seconds after the system time, and the time zone difference to obtain time by using the following formula:

the time=UTC (Universal Time Coordinated) time offset×80±1000+benchmark time, where

UTC time offset=system time−elapsed seconds after the system time×12.5+time zone difference×22500;

the unit of the UTC time offset is 80 milliseconds, the unit of the system time is 80 milliseconds, the unit of the elapsed seconds after the system time is second, the unit of the time zone difference is 30 minutes, and the benchmark time is 00:00 on Jan. 6, 1980.

It should be noted that the time is specific in year, month, day, hour, minute, and second after addition.

For different mobile terminal systems, there are different methods for computing the time, and the foregoing computing method is only taken as an example for illustration herein.

Preferably, after the time is obtained, the obtained time is used for adjusting local time of the mobile terminal, so that the local time is synchronous with the obtained time.

The method provided by this embodiment is applicable to a mobile terminal including a CDMA baseband chip, such as a CDMA1x single-mode terminal, a CDMA1x/EV-DO (Evolution -Data Only) dual-mode terminal, and a CDMA+GSM (Global System for Mobile communications, global system for mobile communications) terminal. In a situation where a UIM card is not inserted in the mobile terminal or the UIM card of the mobile terminal is PIN-enabled but cannot be unlocked, the method provided by this embodiment may be adopted to obtain time.

In the method provided by the present invention, in a situation where time synchronization needs to be implemented and a mobile terminal has no access to a network service, the terminal initiates an emergency call and implements network search during the emergency call process, so as to obtain first signaling, that is, a sync channel message, for interacting with the network during the network search process. Once obtaining the sync channel message, the terminal immediately terminates the initiated emergency call process, extracts time information carried in the sync channel message, and obtains time according to the time information carried in the sync channel message, thereby achieving the purpose of obtaining time from a network side without affecting other services when the terminal has no access to a network service. Further, when the mobile terminal is a multiple baseband chip mobile terminal including at least one CDMA baseband chip, whether the CDMA baseband chip is in the working state is determined, so that when the CDMA baseband chip is not in a working state, the mobile terminal enables the CDMA baseband chip to implement the subsequent emergency call process.

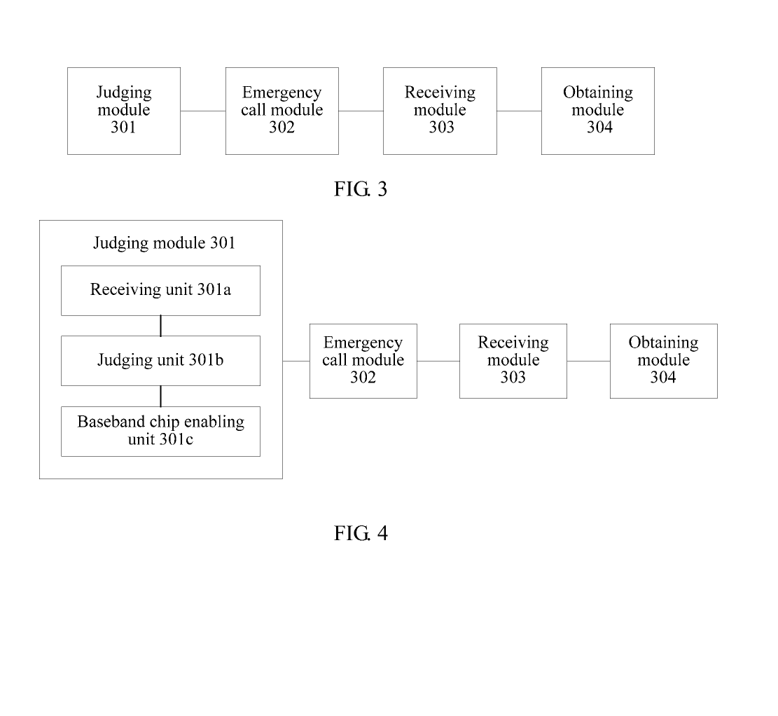

FIG. 3 is a schematic structural diagram of a time obtaining apparatus according to an embodiment of the present invention. Referring to FIG. 3, the apparatus includes:

a judging module 301, configured to receive a time obtaining request and determine whether a mobile terminal has access to a network service;

an emergency call module 302, configured to initiate an emergency call by the mobile terminal when the mobile terminal has no access to a network service;

a receiving module 303, configured to receive a sync channel message which is obtained through searching during the emergency call process, where

the emergency call module 302 is also configured to terminate the emergency call when the receiving module 303 receives the sync channel message which is obtained through searching during the emergency call process, and the sync channel message carries time information; and

an obtaining module 304, configured to obtain time according to the time information.

Preferably, the mobile terminal displays an interface for manually updating time, where the interface includes a time obtaining option, and the mobile terminal receives the time obtaining request sent by a user by triggering the time obtaining option; or

the mobile terminal periodically triggers a time obtaining request according to a preset interval, so that the mobile terminal receives the time obtaining request; or

the mobile terminal triggers a time obtaining request when starting up, so that the mobile terminal receives the time obtaining request.

The time information includes system time, elapsed seconds after the system time, and a time zone difference. The obtaining module 304 is specifically configured to implement computing according to the system time, the elapsed seconds after the system time, and the time zone difference to obtain time.

Preferably, the obtaining module 304 is specifically configured to implement computing according to the system time, the elapsed seconds after the system time, and the time zone difference to obtain time by using the following formula:

the time=universal time coordinated UTC time offset×80±1000+benchmark time, where

UTC time offset=system time−elapsed seconds after the system time×12.5+time zone difference×22500;

the unit of the UTC time offset is 80 milliseconds, the unit of the system time is 80 milliseconds, the unit of the elapsed seconds after the system time is second, the unit of the time zone difference is 30 minutes, and the benchmark time is 00:00 on Jan. 6, 1980.

FIG. 4 is a schematic structural diagram of a time obtaining apparatus according to an embodiment of the present invention. Referring to FIG. 4, the apparatus includes: a judging module 301, an emergency call module 302, a receiving module 303, and an obtaining module 304, where

the judging module 301 includes:

a receiving unit 301a, configured to receive a time obtaining request;

a judging unit 301b, configured to determine whether a CDMA baseband chip is in a working state; and

a baseband chip enabling unit 301c, configured to enable the CDMA baseband chip when the judging unit determines that the CDMA baseband chip is not in a working state, and use the enabled CDMA baseband chip to determine whether the mobile terminal has access to a network service,

or directly use the CDMA baseband chip to determine whether the mobile terminal has access to a network service when the judging unit 301b determines that the CDMA baseband chip is in a working state.

An embodiment of the present invention also provides a mobile terminal, where the mobile terminal includes any one of the foregoing time obtaining apparatuses.

An embodiment of the present invention also provides a mobile terminal, and preferably, the mobile terminal is a mobile phone. The mobile terminal includes any one of the time obtaining apparatuses in the foregoing embodiments of the present invention and further includes: a radio frequency circuit, an audio frequency circuit, and a power supply circuit, where

the radio frequency circuit is configured to establish communication between the mobile phone and a wireless network to implement data receiving and transmission between the mobile phone and the wireless network;

the audio frequency circuit is configured to collect voice and convert the collected voice into voice data, so that the mobile phone sends the voice data to the wireless network through the radio frequency circuit, and/or convert voice data received by the mobile phone from the wireless network through the radio frequency circuit back to voice and play the voice to a user; and

the power supply circuit is configured to supply power to circuits or components of the mobile phone to ensure normal working of the mobile phone.

The terminal device may be a mobile phone, a man-machine interaction terminal, an electronic book, or other terminal devices with a display function. When the terminal device is a mobile phone, the mobile phone also includes a shell, a circuit board, a microphone, and a loudspeaker to complete basic functions of the mobile phone. The following respectively introduces the shell, the circuit board, the microphone, and the loudspeaker.

The circuit board is arranged inside the shell.

The microphone is configured to collect voice and convert the collected voice into voice data, so that the mobile phone sends the voice data to a wireless network through the radio frequency circuit.

The loudspeaker is configured to convert voice data received by the mobile phone from the wireless network through the radio frequency circuit back to voice and play the voice to a user.

The mobile terminal provided by the present invention is a terminal including a CDMA baseband chip, such as a CDMA1x single-mode terminal, a CDMA1x/EVDO dual-mode terminal, or a CDMA+GSM terminal.

A person of ordinary skill in the art may understand that all or a part of the steps of the foregoing embodiments may be implemented through hardware, or may be implemented by a program instructing relevant hardware. The program may be stored in a computer readable storage medium. The storage medium may be a read-only memory, a magnetic disk, or an optical disc.

The foregoing embodiments are only preferred embodiments of the present invention, and are not intended to limit the present invention. Any alteration, equivalent replacement, and improvement made without departing from the spirit and principle of the present invention shall fall within the protection scope of the present invention.

1. A time obtaining method, comprising:
receiving, by a mobile terminal, a time obtaining request, and determining whether the mobile terminal has access to a network service;
initiating, by the mobile terminal, an emergency call when the mobile terminal has no access to a network service;
receiving a sync channel message which is obtained through searching during the emergency call process and terminating the emergency call, wherein the sync channel message carries time information; and
obtaining time according to the time information.

2. The method according to claim 1, wherein the receiving, by a mobile terminal, the time obtaining request comprises:
displaying, by the mobile terminal, an interface for manually updating time, wherein the interface comprises a time obtaining option; and receiving, by the mobile terminal, the time obtaining request sent by a user by triggering the time obtaining option.

3. The method according to claim 1, wherein the time information comprises system time, elapsed seconds after the system time, and a time zone difference, and the obtaining time according to the time information comprises:
implementing computing according to the system time, the elapsed seconds after the system time, and the time zone difference to obtain the time.

4. The method according to claim 3, wherein the implementing computing according to the system time, the elapsed seconds after the system time, and the time zone difference to obtain the time comprises:
implementing computing according to the system time, the elapsed seconds after the system time, and the time zone difference to obtain the time by using the following formula:
the time=universal time coordinated (UTC) time offset×80±1000+benchmark time, wherein
UTC time offset=system time−elapsed seconds after the system time×12.5+time zone difference×22500; and
the unit of the UTC time offset is 80 milliseconds, the unit of the system time is 80 milliseconds, the unit of the elapsed seconds after the system time is second, the unit of the time zone difference is 30 minutes, and the benchmark time is 00:00 on Jan. 6, 1980.

5. The method according to claim 1, wherein the determining whether the mobile terminal has access to the network service comprises:
determining whether a code division multiple access (CDMA) baseband chip is in a working state after the mobile terminal receives the time obtaining request; and
enabling the CDMA baseband chip when the CDMA baseband chip is not in the working state, and using the enabled CDMA baseband chip to determine whether the mobile terminal has access to the network service.

6. A mobile terminal, comprising:
a display unit;
a memory; and
one or more processors coupled to the memory;
wherein the one or more processors are configured to:
receive a time obtaining request, and determine whether the mobile terminal has access to a network service;
initiate an emergency call when the mobile terminal has no access to a network service;
receive a sync channel message which is obtained through searching during the emergency call process and terminate the emergency call, wherein the sync channel message carries time information; and
obtain time according to the time information.

7. The mobile terminal according to claim 6, wherein:
the display unit is configured to display an interface for manually updating time, wherein the interface comprises a time obtaining option; and
the one or more processors are further configured to:
receive the time obtaining request sent by a user by triggering the time obtaining option.

8. The mobile terminal according to claim 6, wherein the one or more processors are further configured to:
receive the time obtaining request periodically according to a preset interval.

9. The mobile terminal according to claim 6, wherein the one or more processors are further configured to:
receive the time obtaining request when the mobile terminal starts up.

10. The mobile terminal according to claim 6, wherein the time information comprises system time, elapsed seconds after the system time, and a time zone difference; and
the one or more processors are further configured to:
implement computing according to the system time, the elapsed seconds after the system time, and the time zone difference to obtain the time.

11. The mobile terminal according to claim 10, wherein the one or more processors are further configured to:
implement computing according to the system time, the elapsed seconds after the system time, and the time zone difference to obtain the time by using the following formula:
the time=universal time coordinated UTC time offset×80±1000+benchmark time, wherein:
UTC time offset=system time−elapsed seconds after the system time×12.5+time zone difference×22500; and
the unit of the UTC time offset is 80 milliseconds, the unit of the system time is 80 milliseconds, the unit of the elapsed seconds after the system time is second, the unit of the time zone difference is 30 minutes, and the benchmark time is 00:00 on Jan. 6, 1980.

12. The mobile terminal according to claim 6, wherein for determining whether the mobile terminal has access to the network service the one or more processors are further configured to:
determine whether a code division multiple access (CDMA) baseband chip is in a working state after the mobile terminal receives the time obtaining request; and
enable the CDMA baseband chip when the CDMA baseband chip is not in the working state, and use the enabled CDMA baseband chip to determine whether the mobile terminal has access to the network service.

13. The method according to claim 1, wherein the receiving, by the mobile terminal, the time obtaining request comprises:
periodically triggering, by the mobile terminal, a time obtaining request according to a preset interval, so that the mobile terminal receives the time obtaining request.

14. The method according to claim 1, wherein the receiving, by the mobile terminal, the time obtaining request comprises:
triggering, by the mobile terminal, a time obtaining request when the mobile terminal starts up, so that the mobile terminal receives the time obtaining request.

15. The method according to claim 1, wherein the determining whether the mobile terminal has access to the network service comprises:
determining whether a code division multiple access (CDMA) baseband chip is in a working state after the mobile terminal receives the time obtaining request; and
directly using the CDMA baseband chip to determine whether the mobile terminal has access to the network service when the CDMA baseband chip is in the working state.

16. The mobile terminal according to claim 6, wherein for determining whether the mobile terminal has access to the network service the one or more processors are further configured to:
determine whether a code division multiple access (CDMA) baseband chip is in a working state after the mobile terminal receives the time obtaining request; and
directly use the CDMA baseband chip to determine whether the mobile terminal has access to the network service when the CDMA baseband chip is in the working state.
